(19) United States
(12) Patent Application Publication
(10) Pub. No.: US 2008/0308487 A1
(43) Pub. Date: Dec. 18, 2008

(54) Filtering device for liquids

(75) Inventors: Michael Thienel, Ludwigsburg (DE); Rainer Loos, Freiberg (DE)

Correspondence Address: Gerhard Voth;MANN+HUMMEL GMBH, Hindenburgstr. 45, Ludwigsburg, DE

(73) Assignee: MANN+HUMMEL GMBH, Ludwigsburg (DE)

(21) Appl. No.: 12/133,256

(22) Filed: Jun. 4, 2008

(30) Foreign Application Priority Data
Jun. 13, 2007 (DE) 20 2007 008 473.0

(51) Int. Cl. B01D 27/08

(52) U.S. Cl. 210/443

(57) ABSTRACT

A filtering device for filtering liquids features a pot-shaped filter housing for receiving a filter element contained therein, the filter housing being removably engaged with a connecting component (such a cover or a flange) by means of a bayonet connection. The bayonet connection includes a first positive-engaged element at the filter housing and a second positive-engaged element secured to the connecting component. The positive-engaged elements are to be brought into an axially positive locking position by axially shifting and rotating them around the housing's longitudinal axis. Furthermore, a blocking stage with a projection extending in axial direction is realized in one positive-engaged element; the allocated positive-engaged element abuts the projection in locking position, which allows also a positive locking position in circumferential direction.

### CROSS REFERENCE TO RELATED APPLICATIONS

This application claims priority benefit under 35 U.S.C. 119 to German Utility Patent Application number 20 2007 008 473.0, having a filing date of Jun. 13, 2007 at the German Patent Office and entitled “Filtering device, in particular liquid filters”.

### TECHNICAL FIELD

The invention relates to a filtering device, particularly to a filtering device for filtering liquids.

### BACKGROUND OF THE INVENTION

European Patent EP 1 236 492 B1 describes a pot shaped liquid filter housing configured to receive a filter element therein. The filter housing is closed by a removable housing cover. To removably secure the cover to the filter housing, a cooperative bayonet connection is provided between the filter housing and filter cover consisting of two radially protruding positive-engaged elements at the inside of the filter housing in the frontally open area and a complementary set of positive-engaged elements at the outside of the cover. The cover is axially inserted into the open side of the filter housing and then rotated until the cooperative positive-engaged elements engage to lock the cover to the housing, thereby locking the position of the cover to the housing in the axial direction.

One drawback of such bayonet connections is that care must be taken to assure that the relative angular position between the filter housing and the cover is correct so as to ensure a safe closure into the locking position. In particular, a continued rotation of the cover beyond the locking position may inadvertently and without warning cause the cooperative bayonet cover to housing connections to disengage with the unexpected effect that the cover has rotationally moved an open position and is no longer locked to the housing.

### SUMMARY OF THE INVENTION

Based on the above prior art, the task addressed by the invention is to further develop a filtering device by means of simple constructional measures to such an extent that the filter housing of the filtering device can be connected with little effort and a high reliability of operation to another connecting component such as a flange or a filter housing cover.

The filtering device according to the present invention is in particular a liquid filter which is preferably used for internal combustion engines, for example as oil filter or as fuel filter. However, utilization for other fluids to be cleaned can be taken into consideration within the scope of the invention; in particular for filtration of a gaseous media such as, for example, air filters. The filtering device features a pot-shaped filter housing into which the filter element is inserted. The filter housing is connected via a bayonet connection with another component which can be, for example, the cover of the filter housing or alternately a connecting flange by which the filtering device can be installed at the intended mounting position.

The bayonet connection includes at least a first positive-engaged element at the filter housing and at least a second positive-engaged element at the other component (for example a filter housing cover or a flange), with which the filter housing has to be connected or which has to be connected with the filter housing. The bayonet connection is realized by an axial sliding, followed by a rotation around the housing's longitudinal axis by first sliding the positive-engaged elements axially past one another and then bringing them into the desired axial positive locking position by rotating them around the housing's longitudinal axis.

According to the present invention it is intended that the first and second positive-engaged elements are also to be brought—in addition to the axial positive engagement in circumferential direction—into a positive locking position. For this purpose, a blocking stage with a projection extending in axial direction is inserted into one positive-engaged element; the second positive-engaged element abuts the projection in locking position. Because of the projection extending in axial direction another relative rotation between the filter housing and the other component is excluded, for the projection seen in circumferential direction forms a stop for the other positive-engaged element. In this way, a positive engagement in axial direction as well as a positive engagement in circumferential direction can be obtained, so that the components which are part of the bayonet connection are reliably locked as desired. As the blocking stage is inserted in one of the positive-engaged elements, the additional locking is obtained with minimal additional constructional effort.

According to an advantageous further development, the positive-engaged element features two blocking stages which define an axially recessed cut-out extending in circumferential direction between them which is intended to accept the corresponding positive-engaged element. Each blocking stage seen in circumferential direction forms a stop for the opposite positive-engaged element, so that a positive engagement is obtained in the locking position in both circumferential directions. To insert the positive-engaged element into the cut-out between both blocking stages it is necessary that the positive-engaged element is at first brought into a position in which it lies axially above the cut-out; however, in this position the positive-engaged element is still at a certain distance to the cut-out. Finally, the positive-engaged element is inserted into the cut-out by shifting it axially; it is now in locking position. To deactivate the locking position, this procedure is carried out in reverse order.

Furthermore, it may be appropriate to envisage a locking device each at the filter housing and the other component which is locked with the filter housing, the locking devices being in an engaged position when they are in locking position and in a disengaged position when they are in non-locking position. The locking devices are meant to indicate that the component is in an engaged position or in a locking position. Consequently, it is possible to recognize the locking position by means of the locking devices.

According to a preferred further development the locking devices includes a stop spring at one component and a snap-on recess at the second component, the stop spring engaging with the snap-on recess in engaged position. This can generate an acoustic and/or haptic signal indicating the locking position. When the stop spring engages with the corresponding snap-on recess an engaging noise or clicking noise is generated which the technician can perceive acoustically. The stop spring is made of metal or plastic. In addition, the slight impact of the stop spring related to the engaging action can also be perceived by the technician. And finally it is also possible to realize an optical indication via the locking devices which can be perceived visually during assembly.

As the connection forces are primarily absorbed by the positive-engaged elements and not by the locking devices, a simple constructive design of the locking devices would be sufficient. As the locking devices have to transfer only minor forces, their design may also feature a lower mechanical stability. Nevertheless, it may be appropriate that a force securing the components in the locking position is also transferred via the locking devices in axial direction and/or circumferential direction.

According to an advantageous further development one of the locking devices is disposed at one of the positive-engaged elements. This positive-engaged element is in particular one that is connected with the other component which is to be connected with the filter housing. For example, the snap-on recess, into which the stop spring engages, which is disposed at the filter housing, can be realized at this positive-engaged element.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 illustrates a section view through a filtering device for an internal combustion engine, consistent with the present invention;

FIG. 2 illustrates a perspective view of a connecting component, in this instance a flange, which is configured to be connected with the filter housing of the filtering device via a bayonet connection;

FIG. 3 illustrates a perspective of a sectional view from the front-sided area of the filter housing depicting a positive-engaged element via which the bayonet connection is to be realized; and

FIG. 4 illustrates a perspective view of a partially free section depicting the connection between the filter housing and a motor vehicle flange.

When identical components are shown in multiple figures they are labeled with the same numerical labels.

### DESCRIPTION OF THE PREFERRED EMBODIMENTS

The following detailed description is of the best currently contemplated modes of carrying out the invention. The description is not to be taken in a limiting sense, but is made merely for the purpose of illustrating the general principles of the invention, since the scope of the invention is best defined by the appended claims.

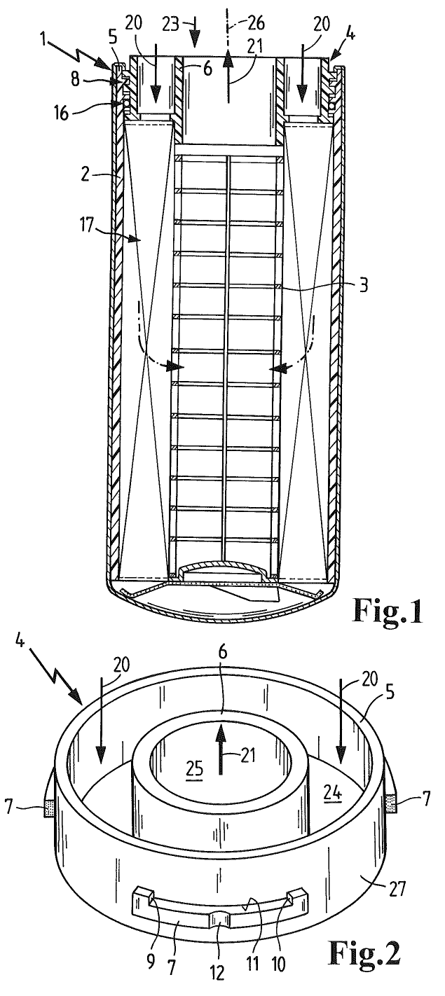

The filtering device 1 shown in FIG. 1 is in particular a liquid filter which is intended for use for an internal combustion engine in a vehicle, for example an oil filter or a fuel filter. The filtering device 1 includes a pot-shaped filter housing 2 configured to receive a filter element (not shown). The filter device 1 directs the fluid flow through the filter element (not shown) to be cleaned. The filter device 1 further includes a supporting structure 3 disposed in the filter housing 2. The supporting structure 3 is configured to support the filter element. The open front end 23 of the filter housing 2 incorporates a connecting component 4 (in the illustrated embodiment, a flange) by which the connection of the complete filtering device 1 to another component of the vehicle or the internal combustion engine is realized. As shown by the arrows (20, 21), the supply of the contaminated fluid 20 and the discharge of the cleaned fluid 21 is carried out through the open front end 23.

As can be seen in FIG. 2, the connecting component 4 (depicted as a flange) is in a bipartite design. Flange 4 includes an external ring 5 and an internal ring 6, the annular space 24 between the external ring 5 and the internal ring 6 as well as the cylindrical space 25 defined by the internal ring 6 provide for the supply 20 and/or the discharge 21 of the fluid. In this example embodiment, the annular space 24 between the rings 5 and 6 is designed for the fluid supply 20 and the internal space enclosed by the internal ring 6 is designed for the discharge 25 of the cleaned filtered fluid from the filtering device 1. At the inside the housing, the supplied unfiltered or contaminated fluid 20 is led radially to the inside through the wall of the filter element (not shown) and is then discharged axially from the filter element (not shown), exiting the filter device 1 as fluid stream 21.

Connecting component 4 is detachably connected to the filter housing 2. To realize this, a bayonet connection is provided which includes positive-engaged elements 7 at the outside of the external ring 5 of the flange 4 as well as corresponding positive-engaged elements 8 at the inside of the filter housing 2 in the area of the open front end 23. In closing position according to FIGS. 1 and 4, the positive-engaged elements 7 and 8 engage with each other in a positive engagement and ensure a firm connection both in axial direction and in circumferential direction. The positive-engaged elements 7 of flange 4 extend radially outwards. The positive-engaged elements 8 at the inside of the filter housing 2 extend radially inwards. A plurality of positive-engaged elements 7, 8 are positioned over the circumference, between which—seen in circumferential direction—a sufficiently large distance is provided to permit sliding the positive-engaged elements 7, 8 axially past one another during assembly of the flange 4 onto the filter housing 2 before a rotation according to the type of bayonet connection is carried out around the longitudinal axis of the filtering device to reach the final locking position.

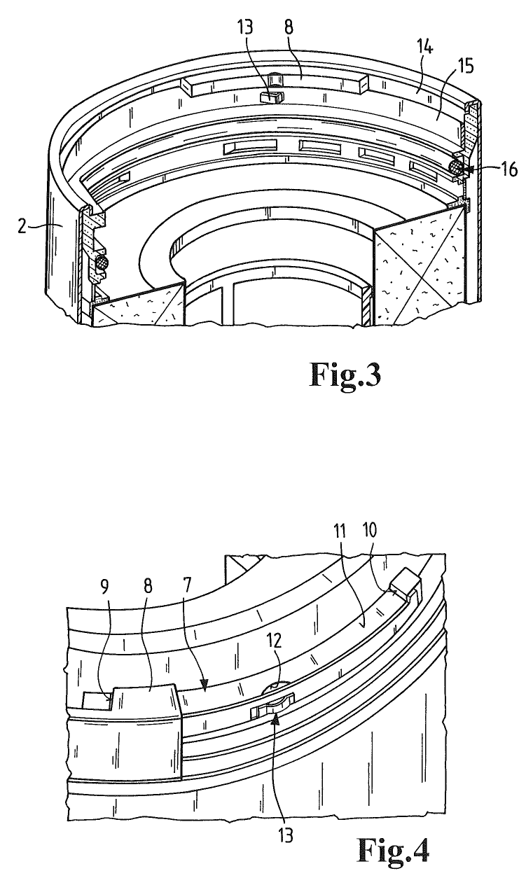

As it can be seen in FIG. 2, at least one positive-engaged element 7 extending in a circumferential direction on flange 4 is depicted having opposing blocking stages 9 and 10 between which an axially recessed cut-out 11 is formed. The blocking stages 9 and 10 each form a stop in opposing circumferential directions. The distance between the blocking stages 9 and 10 and the extension of the axially recessed cut-out 11 in the circumferential direction is adapted to the extension of the allocated positive-engaged elements 8 (see FIG. 3) at the filter housing 2, so that in the locking position one positive-engaged element 8 at the filter housing 2 engages with the axially recessed cut-out 11 at the positive-engaged element 7 (see FIG. 4) which is disposed at flange 4. Advantageously, the opposing blocking stages 9 and 10 form a rotational stop in each circumferential direction to avoid an inadvertent further rotation between the filter housing 2 and flange 4, avoiding an inadvertent decoupling of housing 2 and flange 4.

At the radial outside surface of the positive-engaged element 7 at the flange 4 a snap-on recess 12 is realized approximately in the middle of the positive-engaged element 7 which forms a locking device and cooperates with a further corresponding second locking device designed as stop spring 13 at the filter housing 2. The stop spring that has the reference label 13 is shown in FIGS. 3 and 4. The stop spring 13 is directly located under the positive-engaged element 8 at the inside of the filter housing 2 and adjacent to the open front end 23. The positive-engaged element 8 and the stop spring 13 may be located at different rings 14 and 15 axially directly placed one upon the other, the positive-engaged element 8 and the allocated stop spring 13 being also possibly disposed, if required, at a common ring which is positioned at the inside of the filter housing 2. It is furthermore possible to design the positive-engaged element 8 and/or the stop spring 13 as one-piece with the filter housing 2. It is also possible to change the position of the stop spring 13 and the snap-on recess 12 so that the stop spring 13 is positioned on the element 11 and the snap-on recess 12 is positioned on the filter housing 2.

As it can also be seen in FIG. 3, a gasket 16 is disposed at the inside of the filter housing 2 which contacts the external lateral surface 27 (see FIG. 2) of the flange 4, sealing between the filter housing 2 and the flange 4 when assembled.

FIG. 4 illustrates the stop spring 13 in an engaged position in the snap-on recess 12. During the engagement, an acoustic and/or haptic signal can be generated by means of which a technician can recognize that the filter housing 2 and the flange 4 are both in engaged and therefore in a locked position.

While the best modes for carrying out the invention have been described in detail, those familiar with the art to which this invention relates will recognize various alternative designs and embodiments for practicing the invention within the scope of the appended claims.

1. A filtering device for liquids comprising:
a pot-shaped filter housing (2) sized and configured to receive a filter element therein; and
a connecting component (4) configured to removably engage with said filter housing (2) via a bayonet connection, said bayonet connection including:
a first positive-engaged element (8) secured to said filter housing (2); and
a second positive-engaged element (7) secured to said connecting component (4), said first positive-engaged element (8) and said second positive-engaged element (7) configured to be brought into an axially positive locking engagement in a locking position by an axial shifting and rotation of said filter housing (2) around the housing's longitudinal axis (26) relative to said connecting component (4), wherein said first positive-engaged element (8) and said second positive-engaged element (7) are additionally brought into a positive circumferentially locking engagement in circumferential direction about said longitudinal axis (26) by engagement of said second positive-engaged element (7) with a projection on said second positive-engaged element (7) extending in axial direction and contacting said first positive-engaged element (8) in said locking position.

2. The filtering device according to claim 1, wherein
said circumferentially locking engagement is realized by a first blocking stage (9) and an opposing second blocking stage (10) each secured to said second positive-engaged element (7), both blocking stages (9, 10) defining an axially recessed cut-out (11) extending in circumferential direction between said blocking stages (9,10) for accepting the corresponding first positive-engaged element (8) when in said locking position.

3. The filtering device according to claim 1 or 2, further comprising:
a first locking device (12) provided at said connecting component (4); and
a second locking device (13) provided at said filter housing (2);
wherein said first locking device (12) engages said second locking device (13) when in said locking position;
wherein said first locking device (12) is not engaged to said second locking device (13) when in a non-locking position; and
wherein a transition into said locking position is indicated via said locking devices (12, 13).

4. The filtering device according to claim 3, wherein
one of said locking devices is a snap-on recess (12); and
a different one of said locking devices is a stop spring (13), said stop spring (13) engaging with said snap-on recess (12) in said locking position.

5. The filtering device according to claim 4, wherein said stop spring (13) is disposed at the filter housing (2).

6. The filtering device according to one of the claims 3 to 5, wherein
one of the said locking devices (12, 13) is disposed at one of said positive-engaged elements (7, 8).

7. The filtering device according to claim 6, wherein
said snap-on recess (12) is disposed at said second positive-engaged element (7).

8. The filtering device according to any one of the claims 1 to 7, wherein said filtering device is for an internal combustion engine.

9. The filtering device according to claim 8, wherein said connecting component (4) is a motor vehicle flange.
